(19) United States
(12) Patent Application Publication
(10) Pub. No.: US 2017/0269950 A1
(43) Pub. Date: Sep. 21, 2017

(54) SELECTIVE EXECUTION OF AHEAD-OF-TIME COMPILED CODE

(71) Applicant: MediaTek Inc., Hsinchu (TW)

(72) Inventors: Yu-Lung Lu, Zhunan Township (TW); Hong-Rong Hsu, Hsinchu (TW)

(21) Appl. No.: 15/070,424

(22) Filed: Mar. 15, 2016

(51) Int. Cl. G06F 9/455; G06F 9/45

(52) U.S. Cl. CPC G06F 9/45508; G06F 8/41

(57) ABSTRACT

A device selectively executes native machine code of a computing method in an application. Prior to execution of the application, a predicted usage level of the computing method is determined based on available statistical analysis data of the computing method. According to a determination of whether the predicted usage level exceeds a threshold, a selector selects executable code of the computing method for execution. The executable code is the native machine code or bytecode of the computing method. When the computing method is called during execution of the application, the selected executable code is loaded from non-volatile storage into memory for execution by a virtual machine. Furthermore, runtime usage level of the computing method is monitored to determine whether to switch from bytecode to native machine code execution.

### TECHNICAL FIELD

Embodiments of the disclosure relate to software management of a computing system that hosts a virtual machine.

### BACKGROUND

A virtual machine (VM) is a software emulating implementation of a machine (e.g., a computer) for executing high level programs. A VM provides a platform-independent programming environment that abstracts away details of the underlying hardware or operating system (OS), and allows a high level program to execute in the same way on any platform. One type of VM, sometimes called a Managed Runtime Environment (MRE), runs on top of a host OS to provide an emulation environment for a single process. One example of such a VM is called Java Virtual Machine (JVM). To run in the emulation environment provided by the VM, high level programs (e.g., JAVA) are compiled into a specific bytecode format. Then the VM either compiles or interprets the bytecode into executable machine code for execution on a real hardware machine (e.g., ARM processors, x86 processors, etc.).

Android is a commonly-used mobile framework based on the Linux kernel. Android Runtime (ART) is the VM used by some applications and system services in Android. ART executes its bytecode in the Dalvik Executable (DEX) format to generate machine code for the target device. A DEX file (.dex) holds a set of class definitions and their associated data.

ART introduces the Ahead-of-Time (AOT) compilation by statistically pre-compiling an application into native machine code upon its first installation, first booting or first launching. Compared to its predecessor (e.g., Dalvik), ART improves the overall execution efficiency and reduces power consumption, which results in improved battery autonomy on mobile devices. At the same time, ART brings faster execution of applications, improved memory allocation and garbage collection (GC) mechanisms, new applications debugging features, and more accurate high-level profiling of applications.

ART compiles an application into native machine code by using an on-device utility called dex2oat. Typically at application installation time, this utility accepts an application package with DEX files as input and generates a compiled native machine code executable by the target device. The native machine code is native binary code for a specific hardware processor, and is formatted as Executable and Linkable Format (ELF). The native machine code's filename has .oat as the postfix, and is also referred to as an OAT file.

An OAT file has a faster execution time compared to its DEX counterpart. However, an OAT file takes a significantly larger amount of storage space (e.g., 2-3 times more per application) than a DEX bytecode file. Current Android systems use OAT files by default for application execution, and use DEX files only when there are no OAT files available. Low-cost computing or communicate devices, such as mobile devices, typically have small random access memory (RAM) space for a VM to load executable files. Thus, providing a cost-effective execution environment on such low-cost devices has become a challenge to hardware and software developers.

### SUMMARY

In one embodiment, a method is provided for selectively executing native machine code of a computing method in an application. The method comprises: determining, prior to execution of the application, a predicted usage level of the computing method based on available statistical analysis data of the computing method; selecting executable code of the computing method for execution according to a determination of whether the predicted usage level exceeds a threshold, wherein the executable code is one of bytecode and the native machine code; and loading the selected executable code from non-volatile storage into memory for execution by a VM when the computing method is called during execution of the application.

In another embodiment, a device comprising processing circuitry and memory is provided. The memory contains instructions executable by the processing circuitry to selectively execute native machine code of a computing method in an application. The device is operative to: determine, prior to execution of the application, a predicted usage level of the computing method based on available statistical analysis data of the computing method; select executable code of the computing method for execution according to a determination of whether the predicted usage level exceeds a threshold, wherein the executable code is one of bytecode and the native machine code; and load the selected executable code from non-volatile storage into memory for execution by a VM when the computing method is called during execution of the application.

### BRIEF DESCRIPTION OF THE DRAWINGS

The present disclosure is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

FIG. 1 illustrates Android software architecture according to one embodiment.

FIG. 2 illustrates a device that selectively executes native machine code according to one embodiment.

FIG. 3 illustrates a selective execution process according to one embodiment.

FIG. 4 is a flow diagram illustrating a method of collecting statistics for selective execution according to one embodiment.

FIG. 5A illustrates a compile-time statistics collection scheme according to one embodiment.

FIG. 5B illustrates a runtime statistics collection scheme according to one embodiment.

FIG. 6 is a flow diagram illustrating a method for selective execution according to one embodiment.

### DETAILED DESCRIPTION

In the following description, numerous specific details are set forth. However, it is understood that embodiments of the disclosure may be practiced without these specific details. In other instances, well-known circuits, structures and techniques have not been shown in detail in order not to obscure the understanding of this description. It will be appreciated, however, by one skilled in the art, that the disclosure may be practiced without such specific details. Those of ordinary skill in the art, with the included descriptions, will be able to implement appropriate functionality without undue experimentation.

Embodiments of the disclosure provide a method and system for selective execution of native machine code of a computing method. The computing method, also referred to as a “method,” is in an application that may contain tens or hundreds of methods. The application may be pre-installed on a device, or downloaded (e.g., by flash tools or over-the-air (OTA) download) and then installed on the device. When the application is installed on a device, the bytecode of each of its methods is compiled into corresponding native machine code. When the application is launched (i.e., starts execution) on a device, the selective execution scheme described herein selects, according to a predicted usage level, the bytecode or the native machine code for execution for each method in the application. In one embodiment, the predicted usage level is based on compile-time statistics, profiling data, or a combination of both. The profiling data of a computing method is prior runtime statistics collected from any device (including the device on which the application is launched and other similar devices) on which the same method has been executed previously. When such statistics for a computing method is unavailable or otherwise inaccessible to a device, the device may execute the bytecode of the method by default. Prior to execution of the method, the compiled code (i.e., the native machine code) of a method is selected only when the predicted usage level of the method is above a predetermined threshold.

In the following description, the selective execution scheme is described in the context of Android software. It should be understood, however, the selective execution scheme may be implemented in any software environment that provides VMs for bytecode to machine code translation or compilation. Furthermore, although specific bytecode and machine code file formats, programming languages and utilities are mentioned in the following description, it is understood that the selective execution scheme may apply to any bytecode and machine code file formats, programming languages and utilities. In some parts of the following description, Java application programming language and its related software framework are used as examples; however, it is understood that the selective execution scheme may be applied to machine code generated by VMs that are based on another programming language different from Java.

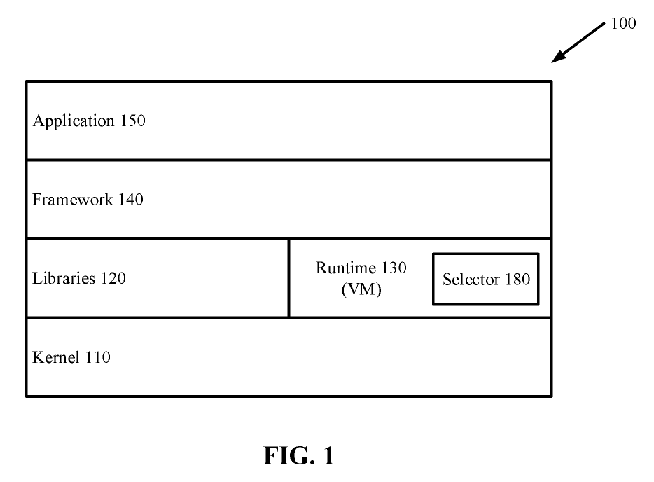

FIG. 1 illustrates Android software architecture 100 according to one embodiment. The architecture 100 consists of five layers. (1) Kernel 110 (e.g., a Linux kernel), which is responsible for basic system functionalities, such as process management, memory management, power management, resource access, and device drivers. (2) Libraries 120, which provide a set of native libraries written in C or C++ programming languages, including libc, SQLite, WebKit, etc. (3) Android Runtime 130, which is a VM with core libraries to execute application programs (e.g., Java code). One of the utilities in the core libraries is dex2oat for generating the native machine code from its DEX bytecode. In addition, the VM also includes a selector 180 which implements the selective execution scheme by selecting native machine code or bytecode for execution by the VM. (4) Android framework 140, which provides higher-level services to applications by Java classes and interfaces. Examples of the services include, but are not limited to, Package Manager Service (PMS) for managing, installing and un-installing application packages, and Activity Manger Service (AMS) for managing all activities for interacting with users. (5) Applications 150, which are programs in high-level programming languages (e.g., Java).

With respect to the Applications 150, typically the Applications 150 are distributed and installed as Android application packages. An application package includes programs and necessary files of an application, and may be compressed, e.g., in a zip format. When an application package is installed on a device, the device may extract the bytecode of the application from the application package.

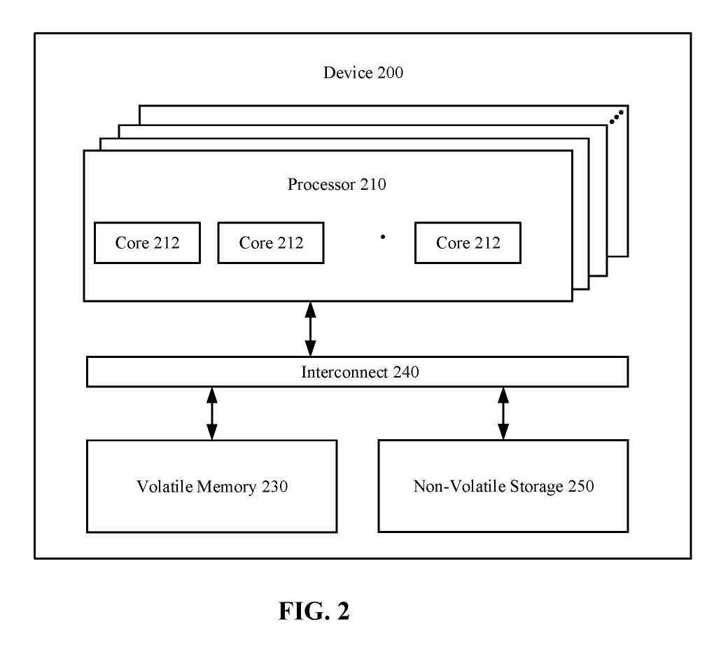

FIG. 2 illustrates a computing system that performs the selective execution of native machine code according to one embodiment. In one embodiment the computing system is a device 200, such as a mobile device or a host computer, that performs computing and/or communication operations. The device 200 includes one or more processors 210 (also referred to as central processing units (CPUs)), and each processor includes one or more cores 212. Each core 212 executes native machine code. In addition, one or more of the cores 212 host one or more VMs for executing application bytecode in a software emulation environment, such as the Android software architecture 100 shown in FIG. 1. The device 200 further includes a volatile memory 230 (e.g., random-access memory (RAM)) for storing code and data, which can be fast accessed during code execution. The device 200 further includes a non-volatile storage 250 (e.g., flash storage, a magnetic data storage device, an optical magnetic data storage device, etc.) for storing the system image, application packages (e.g., .apk files), data cache files, native machine code and bytecode, etc. In general, the size of the non-volatile storage 250 is at least one or two orders of magnitude larger than the size of the volatile memory 230. The device 200 also includes an interconnect 240 (also referred to as a “bus” in some systems) to interconnect the processors 210, the volatile memory 230 and the non-volatile storage 250. In some embodiments, the device 200 also includes peripheral devices such as a display, a camera, a modem, a network interface, etc. In one embodiment, one or more cores 212 of the device 200 perform the selective execution of native machine code as will be described in detail below.

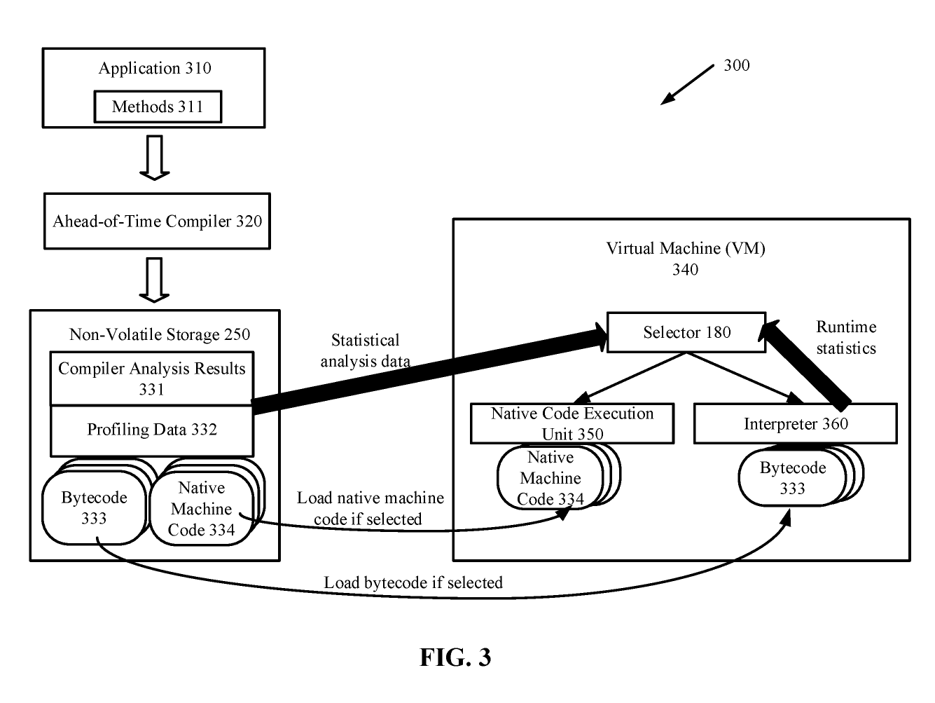

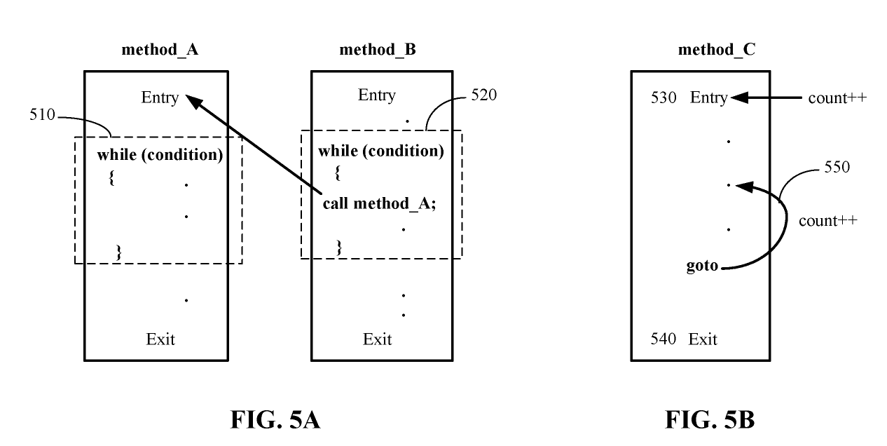

FIG. 3 illustrates a selective execution process 300 performed by a computing system or a device, such as the device 200 of FIG. 2 according to one embodiment. The process 300 begins with an application 310, which includes a set of methods 311, being compiled by an Ahead-of-Time compiler 320 from bytecode to native machine code. The compiler 320 performs static analysis of the application 310 during the compilation. An example of the static analysis performed by the compiler 320 will be described below in connection with FIG. 5A. The compiler output, which includes compiler analysis results 331 and native machine code 334 of each method 311, is stored in the non-volatile storage 250. The non-volatile storage 250 also stores bytecode 333 of each method 311. In one embodiment, the non-volatile storage 250 further stores profiling data 332 of the methods 311, which includes prior runtime statistics generated by the device 200 from prior execution of the application 310, or generated by other devices and downloaded to the device 200.

In one embodiment, a VM 340 is instantiated in the device 200 to execute the application 310. When the application 310 is launched (i.e., starts execution), the VM 340 uses the selector 180 to determine, for each of the methods 311, whether to execute its bytecode 333 or its native machine code 334. The selector 180 calculates or generates a predicted usage level for each method based on the compiler analysis results 331, the profiling data 332, or a combination of both. If the predicted usage level of a method exceeds a first threshold, indicating that the method is “hot”—that is, the method is predicated to be used frequently, then the selector 180 selects the method's native machine code 334 for execution. If the predicted usage level of the method does not exceed the first threshold, then the selector 180 selects the method's bytecode 333 for execution. Neither the native machine code 334 nor the bytecode 333 of the method is loaded into the VM 340 (i.e., loaded from the non-volatile storage 250 to the volatile memory 230 space allocated to the VM 340) at this point. When the application 310 is executed and the method is called, the VM 340 then loads the native machine code 334 or the bytecode 333 of the method according to the selector's 180 launch-time determination or selection. The VM 340 includes a native code execution unit 350 for executing the native machine code 334 of the method, and an interpreter 360 for executing the bytecode 333 of the method. If the method is never called during the execution of the application 310, then neither the native machine code 334 nor the bytecode 333 of the method is loaded into the VM 340.

In one embodiment, both the compiler analysis results 331 and the profiling data 332 may be unavailable, non-existing, or inconclusive with respect to the predicted usage level of a given method. Thus, by default, the selector 180 selects the bytecode 330 of that given method for execution by the interpreter 260. The selector 180 may select any combination of bytecode 333 and native machine code 334 for executing the methods 311 of the application 310. That is, the selector 180 may select the bytecode 333 for some of the methods 311, and may select the native machine code 334 for some others of the methods 311. In some cases, the selector 180 may select the bytecode 333 for all of the methods 311; in some alternative cases, the selector 180 may select the native machine code 334 for all of the methods 311.

In one embodiment, the selective execution is dynamic; that is, bytecode execution can switch to native machine code execution during runtime. In this embodiment, the interpreter 360 collects runtime statistics during the execution of the bytecode 333. An example of the runtime statistics collection is described in connection with FIG. 5B. The interpreter 360 reports the runtime statistics to the selector 180 during runtime. The selector 180 determines whether the runtime statistics indicates that a given method has a runtime usage level exceeding a second threshold. If the runtime usage level exceeds the second threshold, the selector 180 changes its selection for the given method from the bytecode 333 to the native machine code 334. As a result of the changed selection, the native machine code 334 of the given method will be loaded into the VM 340 next time when the given method is called for execution.

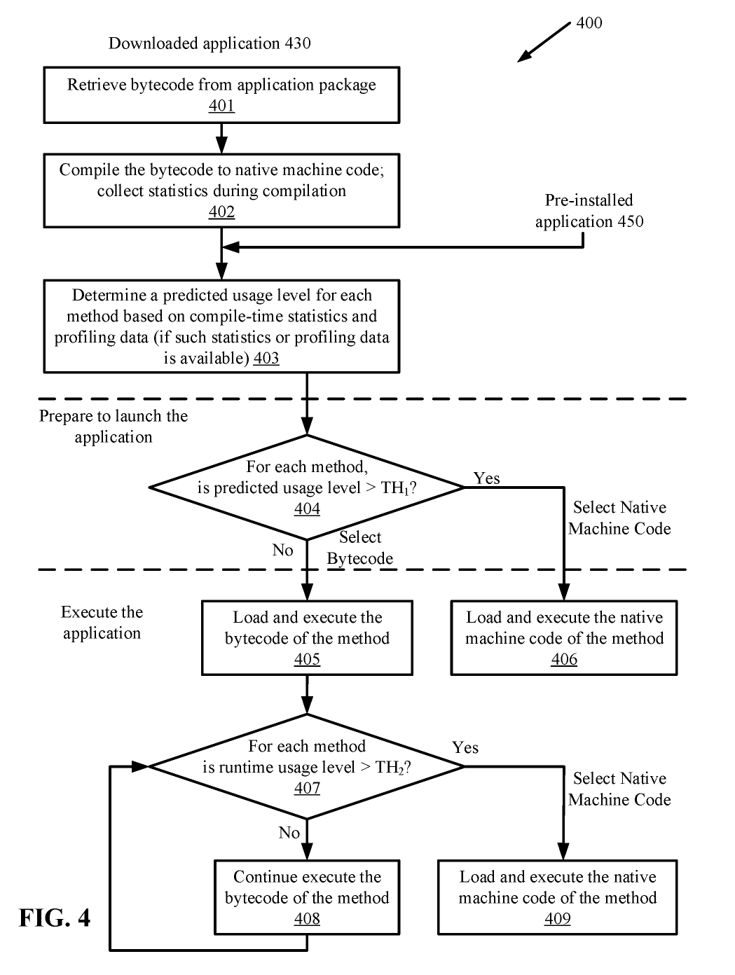

FIG. 4 is a flow diagram illustrating a method 400 of collecting statistics for selective execution according to one embodiment. The method 400 may be performed by a computing system or device, such as the device 200 of FIG. 2. For a downloaded application 430, the method 400 starts with step 401 at which the device retrieves bytecode from an application package. The application package contains an application, which further includes a set of methods. At step 402, the compiler on the device compiles the bytecode to native machine code and performs statistical analysis of the methods during the compilation. For a pre-installed application 450 that has already been compiled, its native machine code and compile-time statistics may have been generated and stored in the device, and the steps 401 and 402 may be skipped. At step 403, the device (more specifically, the VM 340 or the selector 180 of FIG. 3) determines a predicted usage level for each method based on the compile-time statistics and profiling data, if such compile-time statistics or profiling data is available. At step 404, the selector 180 determines whether, for each method, its predicted usage level exceeds a first threshold, TH₁. If the predicted usage level does not exceed TH₁, the selector 180 selects the bytecode of the method. If the predicted usage level exceeds TH₁, the selector 180 selects the native machine code of the method. In addition, if the statistical analysis data (i.e., the compile-time statistics and profiling data) of the method is unavailable, the selector 180 selects the bytecode of the method. During execution of the application when a method is called, its bytecode is loaded into the VM 340 and executed at step 405 if its bytecode was selected. If its native machine code was selected, during execution of the application when the method is called, its native machine code is loaded into the VM 340 and executed at step 406.

At runtime when the bytecode of a given method is executed, the interpreter 360 of FIG. 3 collects its runtime statistics and the selector 180 determines and monitors the runtime usage level based on the runtime statistics. If at step 407 the runtime usage level of the given method exceeds a second threshold, TH₂, then the native machine code of the given method is selected. Next time when the given method is called, its native machine code is loaded into the VM 340 and executed at step 409. If at step 407 the runtime usage level of the given method does not exceed TH₂, then the interpreter 360 continues to execute the bytecode of the given method at step 408. In one embodiment, the runtime usage level of bytecode execution is continuously monitored during runtime; that is, step 408 may loop back to step 407. At any point during the execution if the runtime statistics of a method exceeds TH₂, then the native machine code of that method is selected.

FIG. 5A illustrates a compile-time statistics collection scheme according to one embodiment. In this embodiment, the compiler performs a static analysis on each method in an application during compilation, typically when the application is installed on a device. For example, the compiler may assign a higher predicted usage level to a method (e.g., method_A) that has loops (e.g., a loop 510), can be reached from loops (e.g., a loop 520 of method_B) or a combination of both. On the other hand, the compiler may assign a lower predicted usage level to another method that does not have loops or cannot be reached from loops.

FIG. 5B illustrates a runtime statistics collection scheme according to one embodiment. In this embodiment, the interpreter keeps a counter for each method that has its bytecode or a portion of the bytecode executed. The counter increments by one when the bytecode execution reaches the method's entry point 530 or exit point 540, and when a back edge 550 in the method is encountered. An example of the back edge 550 is a “go to” statement, which causes the execution to jump back to a prior point in the method proceeding the “go to” statement. The execution of the back edge 550 increments the counter value, because a portion of the bytecode is repeatedly executed. The runtime usage level is the counter value or calculated from the counter value. In one embodiment, the runtime statistics collected from one or more devices may be loaded into and used by another device as the profiling data. In another embodiment, the runtime statistics collected from a prior execution of a method on a device may be used as the profiling data for a subsequent execution of the method on the same device or a similar device.

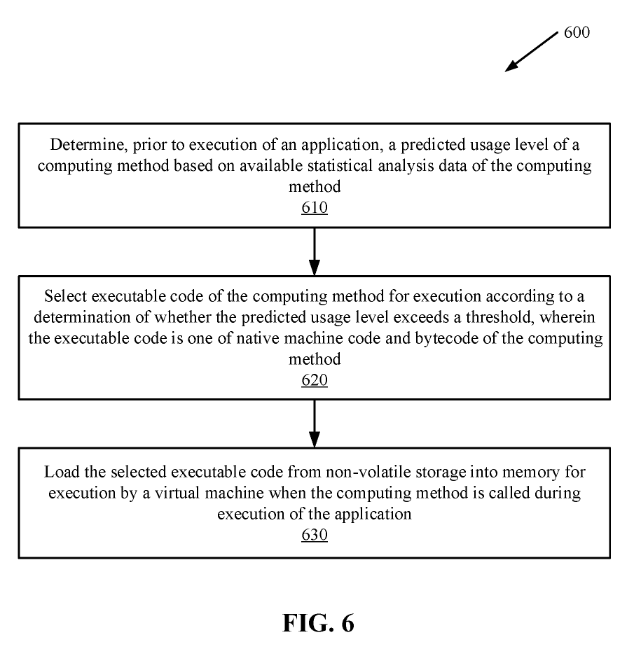

FIG. 6 is a flow diagram illustrating a method 600 for selective execution of native machine code according to one embodiment. The method 600 may be performed by a computing system or a device, such as the device 200 of FIG. 2. In one embodiment, the method 600 may be performed by the VM 340 of FIG. 3. At step 610, prior to execution of an application, a VM determines a predicted usage level of a computing method based on available statistical analysis data of the computing method. At step 620, a selector (e.g., the selector 180 of FIG. 3) in the VM selects executable code of the computing method for execution according to a determination of whether the predicted usage level exceeds a threshold. The executable code is one of native machine code and bytecode of the computing method; that is, the native machine code or the bytecode of the computing method. If the statistical analysis data is unavailable, the selector selects the bytecode by default. The selection is made prior to execution of the application. At step 630, when the computing method is called during execution of the application, the VM loads the selected executable code from non-volatile storage into memory for execution. An example of the non-volatile storage and the memory is shown in FIG. 2 as the non-volatile storage 250 and the volatile memory 230, respectively.

In one embodiment, the application may include multiple computing methods. Each of the computing methods may be processed by the method 600 as described in the steps 610-630 above.

The methods and process of FIGS. 3, 4 and 6 describe a selective execution scheme that may be performed by a mobile device having a RAM much smaller in capacity than its internal storage (e.g., one or two orders of magnitude smaller). The selective execution scheme loads the native machine code into the RAM only when a method is predicted before runtime, or has shown during runtime, to have a high usage level. A method that is predicted before runtime to have a low usage level and remains at a low usage level during runtime has its bytecode loaded into the RAM. A method that is never called during the runtime is not loaded into the RAM at all. Thus, the RAM usage can be reduced significantly due to the smaller size of the bytecode compared with the size of the native machine code.

It is to be understood that the above description is intended to be illustrative, and not restrictive. Many other embodiments will be apparent to those of skill in the art upon reading and understanding the above description. Although the present disclosure has been described with reference to specific exemplary embodiments, it will be recognized that the disclosure is not limited to the embodiments described, but can be practiced with modification and alteration within the spirit and scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

1. A method for selectively executing native machine code of a computing method in an application, comprising:
determining, prior to execution of the application, a predicted usage level of the computing method based on available statistical analysis data of the computing method;
selecting executable code of the computing method for execution according to a determination of whether the predicted usage level exceeds a threshold, wherein selecting the executable code is between bytecode of the computing method and the native machine code that is compiled from the bytecode prior to the selecting of the executable code; and
loading the selected executable code from non-volatile storage into memory for execution by a virtual machine when the computing method is called during execution of the application.

2. The method of claim 1, wherein, when the selected executable code is the bytecode, the method further comprises:
collecting runtime statistics of the computing method during execution of the bytecode; and
in response to a second determination from the runtime statistics that the bytecode has a runtime usage level exceeding a second threshold, selecting the native machine code of the computing method for execution.

3. The method of claim 2, further comprising:
switching from the bytecode to the native machine code of the computing method for execution during execution of the application.

4. The method of claim 2, wherein collecting the runtime statistics further comprises:
incrementing a counter each time the bytecode or a portion of bytecode is executed.

5. The method of claim 1, further comprising:
selecting the bytecode of the computing method when the statistical analysis data of the computing method is unavailable.

6. The method of claim 1, further comprising:
generating at least part of the statistical analysis data of the computing method while an Ahead-of-Time compiler compiles the bytecode into the native machine code before the execution of the application.

7. The method of claim 6, wherein generating the at least part of the statistical analysis data further comprises:
performing a loop analysis on the computing method to determine whether the computing method includes a loop and whether the computing method is reachable from another loop in another computing method.

8. The method of claim 1, further comprising:
receiving profiling data of the computing method before execution of the computing method; and
generating at least part of the statistical analysis data of the computing method from the profiling data.

9. The method of claim 1, wherein the application includes a plurality of computing methods that further include the computing method, the method further comprising:
determining, prior to the execution of the application, a corresponding predicted usage level for each of the computing methods based on the available statistical analysis data of each of the computing methods; and
selecting, prior to the execution of the application, corresponding executable code for each of the computing methods according to a corresponding determination of whether the corresponding predicted usage level exceeds the threshold, wherein the corresponding executable code is one of corresponding bytecode and corresponding native machine code.

10. The method of claim 9, further comprising:
monitoring, during executing the application, a corresponding runtime usage level for each of the computing methods; and
switching from executing the corresponding bytecode to executing the corresponding native machine code when the corresponding runtime usage level of one of the computing methods exceeds a second threshold.

11. A device comprising processing circuitry and memory, said memory containing instructions executable by said processing circuitry to selectively execute native machine code of a computing method in an application, wherein the device is operative to:
determine, prior to execution of the application, a predicted usage level of the computing method based on available statistical analysis data of the computing method;
select executable code of the computing method for execution according to a determination of whether the predicted usage level exceeds a threshold, wherein the executable code is selected between bytecode of the computing method and the native machine code that is compiled from the bytecode prior to the selecting of the executable code; and
load the selected executable code from non-volatile storage into memory for execution by a virtual machine when the computing method is called during execution of the application.

12. The device of claim 11, wherein, when the selected executable code is the bytecode, the device is further operative to:
collect runtime statistics of the computing method during execution of the bytecode; and
in response to a second determination from the runtime statistics that the bytecode has a runtime usage level exceeding a second threshold, select the native machine code of the computing method for execution.

13. The device of claim 12, wherein the device is further operative to:
switch from the bytecode to the native machine code of the computing method for execution during execution of the application.

14. The device of claim 12, wherein the device is further operative to:
increment a counter each time the bytecode or a portion of bytecode is executed.

15. The device of claim 11, wherein the device is further operative to:
select the bytecode of the computing method when the statistical analysis data of the computing method is unavailable.

16. The device of claim 11, wherein the device is further operative to:
generate at least part of the statistical analysis data of the computing method while an Ahead-of-Time compiler compiles the bytecode into the native machine code before the execution of the application.

17. The device of claim 16, wherein the device is further operative to:
perform a loop analysis on the computing method to determine whether the computing method includes a loop and whether the computing method is reachable from another loop in another computing method.

18. The device of claim 11, wherein the device is further operative to:
receive profiling data of the computing method before execution of the computing method; and
generate at least part of the statistical analysis data of the computing method from the profiling data.

19. The device of claim 11, wherein the application includes a plurality of computing methods that further include the computing method, the device is further operative to:
determine, prior to the execution of the application, a corresponding predicted usage level for each of the computing methods based on the available statistical analysis data of each of the computing methods; and
select, prior to the execution of the application, corresponding executable code for each of the computing methods according to a corresponding determination of whether the corresponding predicted usage level exceeds the threshold, wherein the corresponding executable code is one of corresponding bytecode and corresponding native machine code.

20. The device of claim 19, wherein the device is further operative to:
monitor, during executing the application, a corresponding runtime usage level for each of the computing methods; and
switch from executing the corresponding bytecode to executing the corresponding native machine code when the corresponding runtime usage level of one of the computing methods exceeds a second threshold.
